(19) United States
(12) Patent Application Publication
(10) Pub. No.: US 2019/0050299 A1
(43) Pub. Date: Feb. 14, 2019

(54) Method of Secure Storage Medium Backup and Recovery

(71) Applicant: Donald A. Rowe, Pittsburgh, PA (US)

(72) Inventor: Donald A. Rowe, Pittsburgh, PA (US)

(21) Appl. No.: 16/102,793

(22) Filed: Aug. 14, 2018

Related U.S. Application Data
(60) Provisional application No. 62/545,128, filed on Aug. 14, 2017.

(51) Int. Cl. G06F 11/14; G06F 21/73; G06F 21/60; H04L 29/06

(52) U.S. Cl. CPC G06F 11/1469; G06F 21/73; G06F 2201/84; H04L 63/1441; H04L 63/1416; G06F 21/602

(57) ABSTRACT

In a method of backup and recovery of file(s) and/or folder(s) stored on a non-volatile computer readable storage medium, a serial number of a recovery drive connected in operative communication with processor of a computer system, but not mounted to the operating system, is used to mount the recovery drive to the operating system. The processor copies file(s) and/or folder(s) stored on an internal drive to the recovery drive and then unmounts the recovery drive using the serial number. Following an encrypting ransomware attack, the same or another instance of the serial number of recovery drive is used to mount the recovery drive, whereafter the file(s) and/or folder(s) stored on the recovery drive are copied or restored to the internal drive. Finally, the recovery drive is unmounted using the serial number.

### CROSS REFERENCE TO RELATED APPLICATION

This application claims the benefit of U.S. Provisional Application No. 62/545,128, filed Aug. 14, 2017, the contents of which is incorporated in its entirety herein by reference.

### BACKGROUND OF THE INVENTION

Ransomware downloaded via the Internet is increasingly being used to extort money from victims. One type of ransomware is encrypting ransomware which incorporates encryption algorithms designed to block access to files stored in a permanent computer readable storage medium on or accessible by a computer, in particular the computer's operating system and demand payment to provide the victim with a key that can be used to decrypt the blocked content.

Because of the quickly evolving nature of encrypting ransomware software, typical antivirus software is unable to keep up with the latest trends in encrypting ransomware software. Hence, typical antivirus software can often fail to identify encrypting ransomware software being downloaded into a user's computer or computer system in any manner, e.g., via the Internet, and executed on the user's computer or computer system and, hence, is unable to avoid or prevent the encrypting ransomware attack.

### SUMMARY OF THE INVENTION

Generally, provided, in one preferred and non-limiting embodiment or example, is a method wherein unencrypted copies of the software files and/or folders can be backed-up from a first computer readable storage medium to a second computer readable storage medium prior to an encrypting ransomware attack and the unencrypted copies can be copied back to the first computer readable storage medium following the encrypting ransomware attack

The technical problem to be solved is how to avoid the backup files and/or folders stored on the second computer readable storage medium from being encrypted during an encrypting ransomware attack when the second computer readable storage medium is connected to the computer system during the encrypting ransomware attack.

The solution to this technical problem is to, starting from a state where the second computer readable storage medium is inactive to the computer's operating system, make the second computer readable storage medium active to the computer's operating system during backup of the files and/or folders from the first computer readable storage medium to the second computer readable storage medium prior to an encrypting ransomware attack; to make the second computer readable storage medium inactive to the computer's operating system after backup and prior to the encrypting ransomware attack; and, following an encrypting ransomware attack, make the second computer readable storage medium once again active to the computer's operating system and then copy the backed-up files and/or folders from the second computer readable storage medium to the first computer readable storage medium.

The solution is an improvement over conventional backup solutions that require a backup computer readable storage medium to be physically removed from the computer system to avoid the backup files from being encrypted during an encrypting ransomware attack. A benefit of this solution is that files and/or folders encrypted during encrypting ransomware attack on the first computer readable storage medium can be quickly restored to the first computer readable storage medium from the second computer readable storage medium which, in an example, can remain connected to the computer system during the encrypting ransomware attack. Another benefit of this solution is that backup and/or restoration can be automated thereby avoiding the need to have the backup computer readable storage medium physically connected to the computer system during backup and then physically disconnected after backup.

Further preferred and non-limiting embodiments or examples are set forth in the following numbered clauses.

Clause 1: A method of backup and recovery of files and/or folder stored on a non-volatile computer readable storage medium comprises: (a) receiving, with a computer system comprising an internal drive and a processor running an operating system having the internal drive mounted to the operating system, a first instance of a serial number of a recovery drive operatively connected in communication with the processor, but not mounted, to the operating system; (b) mounting, by the processor to the operating system, the recovery drive using the first instance of the serial number to communicate with the recovery drive; (c) following step (b), copying, by the processor, of one or more files and/or one or more folders stored on the internal drive to the recovery drive; (d) unmounting, by the processor from the operating system, the recovery drive using the first instance of the serial number; (e) following step (d), executing by the processor encryption software; (f) following step (e), receiving, with the computer system, a second instance of the serial number of the recovery drive; (g) mounting, by the processor to the operating system, the recovery drive using the using the second instance of the serial number to communicate with the recovery drive; (h) following step (g), copying, by the processor, the one or more files and/or the one or more folders stored on the recovery drive to the internal drive; and (i) unmounting, by the processor from the operating system, the recovery drive using the first or second instance of the serial number.

Clause 2: The method of clause 1, wherein step (e) can include receiving the encryption software by an internet connection of the computer system.

Clause 3: The method of clause 1 or 2, wherein: in step (a), the first instance of the serial number can be included in a backup file stored on the internal drive; and in step (e), the backup file can be encrypted by the encryption software, whereupon the first instance of the serial number included in a backup file is no longer available to the operating system.

Clause 4: The method of any one of clauses 1-3, wherein: step (f) can include mounting, by the processor to the operating system, a backup drive that includes a recovery program that includes the second instance of the serial number; and executing, by the processor, recovery program that causes the processor to execute steps (g)-(i).

Clause 5: The method of any one of clauses 1-4, wherein step (f) can be executed by the processor automatically in response to connection of the backup drive in operative communication with the processor.

### BRIEF DESCRIPTION OF THE DRAWING(S)

These and other features of the present invention will become more apparent from the following description in which reference is made to the appended drawings wherein:

FIG. 1 is a schematic illustration of an example computer system according to the principles of the present invention; and

FIGS. 2A-2B are an example flow diagram of a method according to the principles of the present invention.

### DESCRIPTION OF THE INVENTION

Various non-limiting examples will now be described with reference to the accompanying figures where like reference numbers correspond to like or functionally equivalent elements.

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the example(s) as oriented in the drawing figures. However, it is to be understood that the example(s) may assume various alternative variations and step sequences, except where expressly specified to the contrary. It is also to be understood that the specific example(s) illustrated in the attached drawings, and described in the following specification, are simply exemplary examples or aspects of the invention. Hence, the specific examples or aspects disclosed herein are not to be construed as limiting.

Applicant has discovered that while encrypting ransomware attacks encrypt files on a user's system, such attacks do not encrypt files that are presently in use at the time of the encrypting ransomware attack. Accordingly, in the event of an encrypting ransomware attack, the files presently in use at the time of the encrypting ransomware attack can be available for use following the encrypting ransomware attack.

One or more of the files in use at all times is a computer's operating system. Hence, during and after an encrypting ransomware attack, the operating system itself can be available for use.

Upon physically connecting a computer readable storage medium e.g., a hard disk drive, a solid-state drive, a flash drive, a CD ROM drive, or any other type of computer readable storage medium, to the computer system, the operating system automatically assigns a drive letter, e.g., “C”, to the readable storage medium. The process by which the operating system assigns a drive letter to the computer readable storage medium is known as “mounting”. In other words, the drive is “mounted” to the drive letter by the operating system. For the purpose of description herein, commands implemented by the Microsoft Windows operating system will be used to describe the invention. However, this is not to be construed in a limiting sense.

More specifically, in order for a computer readable storage medium to be accessible by the operating system, it must first be mounted. This is a software process that “activates” the computer readable storage medium and makes the folders and files on the computer readable storage medium readable by the operating system. If a computer readable storage medium is physically connected, but not mounted, the computer's operating system will not recognize it.

Most operating systems, such as Microsoft Windows and Apple's Mac OS X, mount newly connected computer readable storage mediums automatically. In Windows, the computer readable storage medium will appear in the “My Computer” window. In Mac OS X, the computer readable storage medium will appear on the desktop or in the file titled “Finder”. This is true for all types of computer readable storage mediums, such as, without limitation, internal and external hard drives or solid state drives, optical media, such as CDs and DVDs, and USB flash drives.

If a computer readable storage medium is not being used, it may be unmounted. Unmounting is a software process that “deactivates” the computer readable storage medium and makes the folders and files on the computer readable storage medium inaccessible by the computer operating system. Of course, in order for a computer readable storage medium to be unmounted, it must first be mounted. When a computer readable storage medium is mounted, it is active and the operating system can access its folders and files. Unmounting a computer readable storage medium prevents the operating system from accessing its folders and files.

Once a computer readable storage medium is mounted to a drive letter by the computer operating system, it becomes vulnerable to an encrypting ransomware attack which can use the assigned drive letters to find each mounted computer readable storage medium and encrypt the files and/or the folders stored thereon.

For the purpose of simplicity of description, hereinafter, a hard drive or drive, albeit a hard disk drive or a solid-state drive, will be used as an example of a computer readable storage medium. However, this is not to be construed in a limiting sense, since the use of any suitable and/or desirable form of computer readable storage medium, or memory, now known or hereinafter developed, that includes a serial number that is addressable by the computer operating system is envisioned. Moreover, as used hereinafter a hard drive or drive can also or alternatively mean a partition of a hard drive or drive.

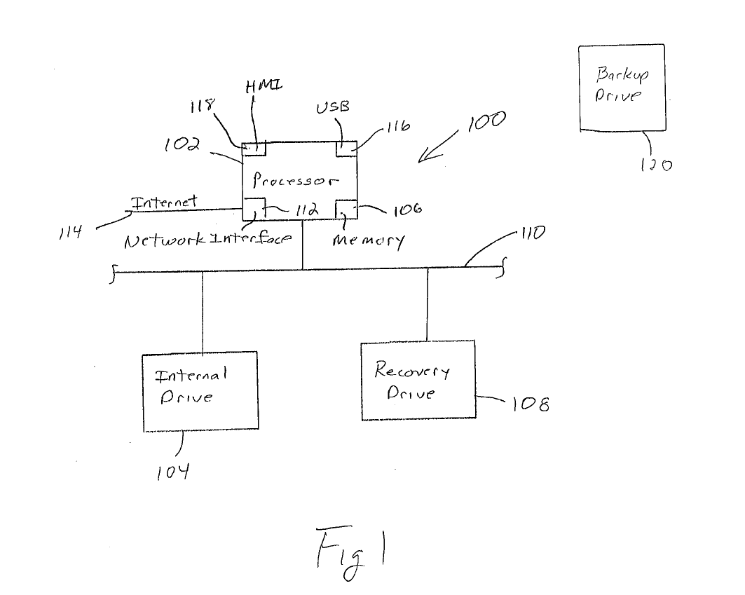

Referring to FIG. 1, in an example, to a computer system 100 comprising a processor 102, a memory 106, and a dedicated internal drive 104 can also be connected a recovery drive 108. Internal drive 104 and recovery drive 108 can be connected and in communication with processor 102 via, for example, a computer bus 110 of system 100 in a manner known in the art. In a manner known in the art, processor 102 operates under the control of the computer operating system to control the various functions of system 100 in a manner known in the art.

In an example, recovery drive 108 can be (a) internal to system 100, (b) networked to system 100, e.g., via a wired and/or wireless communication path or network, or (c) removably, physically connected to system 100, for example, via a USB or similar plug-in connection. For the purpose of the following description, recovery drive 108 will be described as being internal to system 100 (in addition to internal drive 104). However, this is not to be construed in a limiting sense since the use of any physical and/or wireless connection of recovery drive 108 to processor 102 that enables processor 102 to read and/or write to recovery drive 108 is envisioned.

When recovery drive 108 (or any drive for that matter) is initially connected to bus 110, processor 102, operating under the control of the operating system, detects the connection of recovery drive 108 and automatically mounts recovery drive 108 to a drive letter (e.g., D). Information regarding the correspondence of recovery drive 108 to a drive letter is stored by the operating system in a registry location accessible to the operating system. This information can include correspondence between the assigned drive letter and a unique serial number assigned recovery drive 108 by the manufacturer of recovery drive 108.

Once recovery drive 108 is mounted to a drive letter, and prior to an encrypting ransomware attack, the mounted recovery drive 108 can be unmounted using the operating system's “unmount” command and recovery drive's 108 serial number assigned to recovery drive 108 by the manufacturer of recovery drive 108. In other words, via recovery drive's 108 serial number, the operating system is able to uniquely identify and communicate with the hardware corresponding to recovery drive 108 and is, in software, able to unmount recovery drive 108, whereupon the drive letter assigned to recovery drive 108 when recovery drive 108 was mounted is removed from its storage location (deleted from its registry location), whereupon recovery drive 108 no longer has a drive letter assigned to it.

Unmounting recovery drive 108 renders recovery drive 108 inaccessible in normal use of the operating system, even though recovery drive 108 is still operatively connected to the processor 102. Stated differently, once unmounted, recovery drive 108 is no longer associated with a drive letter, whereupon recovery drive 108 is no longer accessible by the operating system in normal use.

The following describes the process for performing a backup and recovery using recovery drive 108.

Backup Procedure:

Starting from a state with recovery drive 108 physically connected to bus 110 but unmounted, internal drive 104 can be backed up onto recovery drive 108. This backup can be performed manually or automatically, in a manner know in the art, e.g., via software instructions included in a file, e.g., a compiled software program file or a run-time executable script file. In one non-limiting example, upon execution of the instructions included in the file on system 100, the instructions can cause the operating system to insert the serial number of recovery drive 108 into a backup file, e.g., “A_DDPscript.BAT”, which can be stored in memory 106 of system 100. While the backup file (or, more specifically, a program stored in the backup file) is executed by processor 102, the serial number of recovery hard drive 108 included in the backup file enables the operating system to “find” or address the unmounted recovery drive 108, mount recovery drive 108, and assign it a unique, unused drive letter. In an example, the process of mounting utilizes the operating system's command prompt “mount”.

The instructions included in the file executed by processor 102 can also cause the drive letter of internal drive 104 to be backed up and/or the names of any files stored on internal drive 104 to be backed up to recovery drive 108 to be inserted into the backup file.

In this example, the instructions included in the file executed by processor 102 can cause processor 102 to insert into the backup file (i) the serial number of recovery drive 108, and at least one of the following: (ii) the drive letter of internal drive 104 to be backed up to recovery drive 108, and/or (iii) the names of any files stored on internal drive 104 to be backed up to recovery drive 108. In an example, some or all of this information (i), (ii), and/or (iii) can be included in the file that includes the instructions. In another example, the backup file itself can include this information thereby obviating the need for the file including the instructions to insert this information in the backup file.

The foregoing is not to be construed in a limiting sense since it is envisioned, in an example, that one or more alternate methods of backup can be used where the information (i), (ii), and/or (iii) is used instead. Accordingly, the description herein of a file including instructions that causes processor 102 to transfer the information (i), (ii), and/or (iii) into the backup file is to be understood as being but one non-limiting example and is not to be construed in a limiting sense.

Recovery drive 108 is marked as active during mounting. Once recovery drive 108 is mounted, the process of backing up computer data, e.g., files and/or folders, from the system's internal drive 104 onto the mounted recovery drive 108 can be, under the control of the operating system, run or executed by processor 102. In an example, a backup, or the process of backing up, refers to the copying and archiving of computer data, e.g., files and/or folders.

Once backup of internal drive 104 to recovery drive 108 is complete, the instructions executed by processor 102 can cause the operating system to mark recovery drive 108 as inactive using the operating system's “unmount” command and recovery hard drive's 108 serial number in the manner discussed above Once unmounted, recovery drive 108 will no longer have a drive letter associated therewith in the operating system registry and, therefore, in normal use, the operating system will no longer be able to access recovery hard drive 108, even though recovery hard drive 108 is still connected to bus 110. In this manner, in the event of an encrypting ransomware attack, the files on recovery drive 108 are not encrypted. Rather, only the computer data, e.g., file(s) and/or folders, stored on system's 100 internal drive 104 mounted to system 100 are encrypted.

The process of backing up one or more internal drives 104 onto one or more recovery drives 108 can be performed manually or automatically, e.g., via software instructions included in a file. The backing up of an internal drive 104 onto a recovery drive 108 can be performed at a convenient time, periodically, aperiodically, or upon user initiation.

In event of an encrypting ransomware attack, the encrypting ransomware software will encrypt some or all of the file(s) and/or folders stored on hard drives, e.g., internal drive 104, mounted to system 100 that are NOT in use by system 100 at the time of the encrypting ransomware attack. In an example, such encryption can include encrypting the backup file stored on internal drive 104 as discussed above. In another example, any file stored on the internal drive 104 and not in use at the time of the encrypting ransomware attack that includes the serial number of recovery drive 108 can also be encrypted. A benefit of encrypting a file or files that may include the serial number of recovery drive 108 is that the serial number of recovery hard drive 108 is also encrypted thereby avoiding the serial number of recovery drive 108 from being subsequently exposed to a hack of system 100.

As noted above, the encrypting ransomware software will not encrypt any files currently in use by the system, including the operating system in use at the time the encrypting ransomware software executes. Hence, the operating system will still be operable but, because the backup file is encrypted, automatic or manual backup of internal drive 104 onto recovery drive 108 using the backup file is also disabled.

Recovery Procedure:

To recover data on internal drive 104 after an encrypting ransomware attack, starting from a state with the operating system operating and fully functional, a recovery software program stored in a recovery file that is not stored or accessible to system 100 in normal use or at least during the encrypting ransomware attack can be executed. In an example, recovery file can be stored on a backup drive 120. In an example, backup drive 102 can be a CD Rom, a USB drive or another computer readable storage medium that can be connected to system 100 follow the encrypting ransomware attack. In an example, recovery program can programmed with the serial number of recovery drive 108. In another example, recovery program can be programmed or configured to receive as automated or manual data entry the serial number of recovery drive 108 for additional security.

Recovery program can include instructions that cause the operating system to mount recovery drive 108 using the serial number of recovery drive 108 programmed into or received by recovery program. Once mounted, recovery drive 108, which includes the computer data, e.g., files and/or folders, that were copied from internal drive 104 prior to the encrypting ransomware attack and, therefore, have not been encrypted by the encrypting ransomware attack, is once again fully accessible by the operating system.

Once recovery drive 108 has been mounted following an encrypting ransomware attack, recovery program can cause the operating system's “restore” function to be executed to restore the system's internal drive 104 from recovery drive 108. More specifically, file(s) and/or folder(s) of internal drive 104 stored on recovery drive 108 during the backup procedure described above can be copied from recovery drive 108 back to internal drive 104 during this backup procedure. In an example, the system's internal drive 104 being “restored” can be internal drive 104 that was subject to the encrypting ransomware attack or a replacement internal drive 104.

Once the system's internal drive 104 has been restored from recovery drive 108, recovery program can cause the operating system to unmount recovery drive 108 using the serial number of recovery drive 108 and the unmount command in the manner described above, whereupon the operating system of system 100 no longer has access to recovery drive 108, even if recovery drive 108 is operatively connected to processor 102.

Once the restore function is complete, the system's internal drive 104 will include unencrypted copies of the files restored from recovery drive 108.

In an example, recovery program included on backup drive 120 that can be connected to system 100 following the encrypting ransomware attack can be launched by an end user or automatically, in a manner known in the art, upon connection of backup drive 120 to system 100.

While that foregoing example is described with reference to an internal drive 104 physically connected to bus 110, this is not to be construed in a limiting sense since it is envisioned, in an example, that internal drive 104 can be a network drive that is accessible by processor 102 via a network interface 112 of system 100 and an external computer network (e.g., a local or wide area network, such as Internet 114) connected to network interface 112 in a manner know in the art. Moreover, for example, instead of recovery drive 108 being physically connected to bus 110, recovery drive can be a network drive that is accessible by processor 102 via the external computer network connected to network interface 112 in a manner know in the art and which can be mounted and unmounted in the manner discussed above. in an example, the external computer network can be a wired network, a wireless network, or some combination of a wired and wireless network.

In another example, recovery drive 108 can be removably connected to the system, e.g., via a USB connection 116. In this example, to avoid recovery drive 108 from being subject to an encrypting ransomware attack when connected to processor 102, instructions can be prepared and stored on internal drive 104 that can automatically execute, in a manner know in the art, when, at least, recovery drive 108 is physically connected, e.g., via the USB connection, to automatically unmount recovery drive 108. Thereafter, recovery drive 108 can, in the manner described above, be mounted for backup purposes, unmounted once backup is complete, and mounted for recovery purposes as needed.

In one preferred and non-limiting embodiment or example, any one or some or all of internal drive 104, recovery drive 108, and/or backup drive 120 can, in an example, be non-volatile computer readable storage medium.

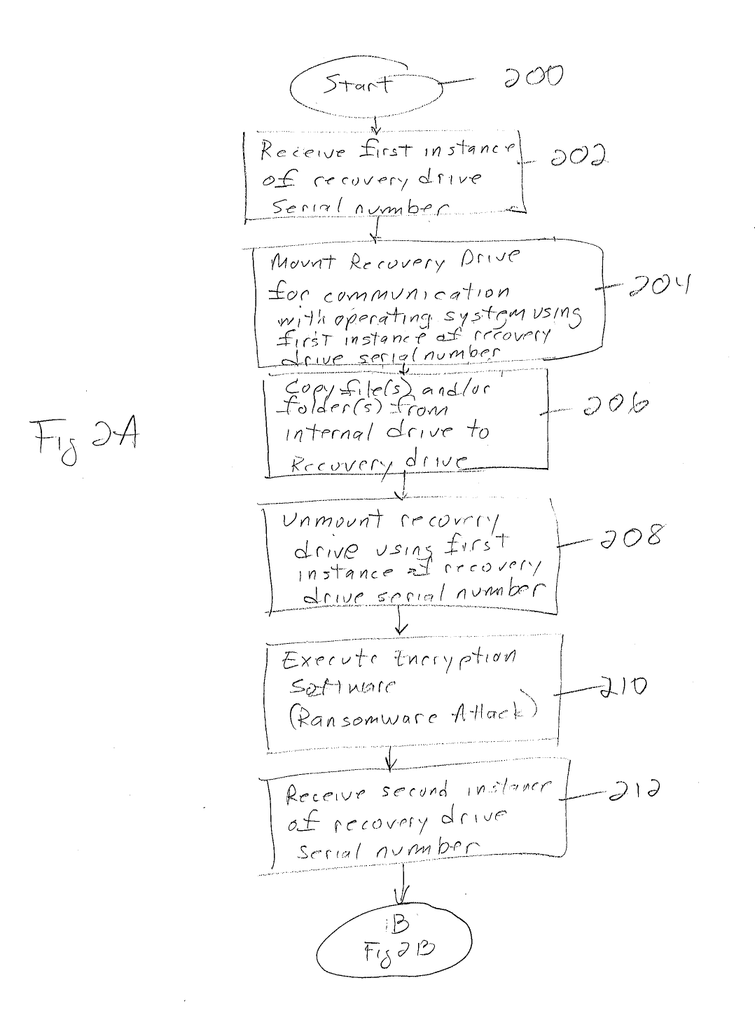

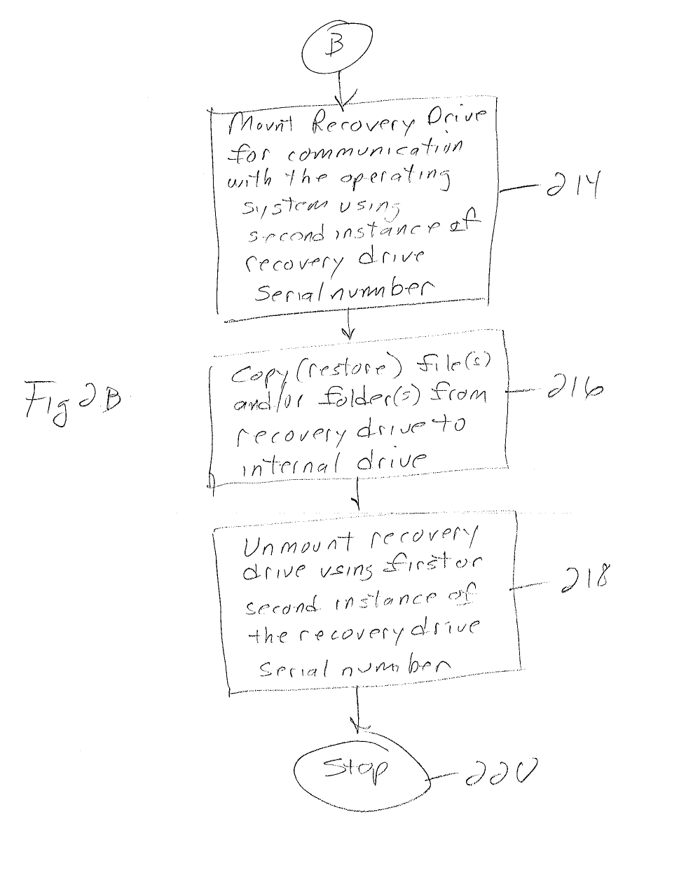

Referring to FIGS. 2A-2B and with continuing reference to FIG. 1, one preferred and non-limiting embodiment or example method of backup and recovery of file(s) and/or folder(s) stored on a non-volatile computer readable storage medium will now be described. The method beings by advancing from start step 200 to step 202. In step 202, computer system 100, comprising internal drive 104 and processor 102 running an operating system having internal drive 104 mounted to the operating system, receives a first instance of a serial number of recovery drive 108 operatively connected in communication with processor 102, but not mounted, to the operating system. The method then advances to step 204, wherein processor 102 mounts the recovery drive 108 to the operating system using the first instance of the serial number. In step 206, processor 102 copies one or more files and/or one or more folders stored on internal drive 104 to recovery drive 108. In step 208, processor 102 unmounts recovery drive from the operating system using the first instance of the serial number.

In step 210, computer system 100 is subject to an encrypting ransomware attack, wherein processor 102 executes encryption software that encrypts one or more files and/or one or more folders stored on internal drive 104 that are not presently in use by processor 102 at the time of the encrypting ransomware attack. The method then advances to step 212, wherein a second instance of the serial number of recovery drive is received by computer system 100. In step 214, the recovery drive is mounted to the operating system using the using the second instance of the serial number. In step 216, processor 102 copies (or restores) the one or more files and/or the one or more folders stored on recovery drive 108 to the internal drive 104 In step 218 recovery drive 108 is unmounted from the operating system using the first or second instance of the serial number. The method then advances to stop step 220.

In an example, the encryption software can be received by computer system 100 via an internet connection of the computer system. In an example, the first instance of the serial number can be included in a backup file stored on the internal drive. The backup file can be encrypted by the encryption software whereupon the first instance of the serial number included in a backup file is no longer available to the operating system.

In an example, the second instance of the serial number can be received from a backup drive that is mounted to the operating system. In an example, the backup drive can include a recovery program that includes the second instance of the serial number. The processor can execute the recovery program that causes the processor to execute steps 214, 216, and 218. In an example, Step 212 can be executed by the processor automatically in response to connection of the backup drive in operative communication with the processor.

Options for performing a backup can include, for a single system hard drive, internal drive 104 is backed up to recovery drive 108 every time the backup file is executed. For a system 100 that includes a single internal drive 104 with two partitions, each partition can be backed up onto recovery drive 108 alternating times the backup file is executed.

Where system 100 includes two internal drives 104, each internal drive 104 can be backed up to recovery drive 108 on an alternating schedule. In another example, when recovery drive 108 has sufficient capacity, each of the two internal drives 104 can be backed up to recovery drive 108 on an alternating schedule.

In another example, where system 100 is connected to three recovery drives 108, two recovery drives 108 can be used for backup on an alternating schedule while the third recovery drive 108 can be used to backup one or more of the system's 100 internal drives 104 on a longer schedule. For example, the two recovery drives 108 can be used to perform backups of the system's 100 internal drives 104 on alternating days while the third recovery drive 108 can be used for backup monthly.

Other examples for backup can include, where C is internal drive 104, D is another internal drive 104′, X is recovery drive 108, and Y is a second recovery drive 108′:
C backs up to X every day;
C and D backup to X every day;
C backs up to X partition 1 on odd days and X partition 2 on EVEN days (A/B schedule)
C and D back up to X partition 1 on odd days and X partition 2 on even days (A/B schedule);
D backs up to X partition 1 on odd days and X partition 2 on even days (A/B schedule) and C backs up to X partition 1 monthly; and
C and D backup to X partition 1 on odd days and X partition 2 on even days (A/B schedule) and backup to Y monthly.

As can be seen, disclosed herein is a method of secure storage medium backup and recovery. In one preferred and non-limiting embodiment or example, a serial number of recovery drive 108 can be included in or entered into a backup file that is stored on an internal drive 104 of computer system 100 in any suitable and/or desirable matter, e.g., via a human machine interface (HMI) 118 of system 100 coupled to processor 102 in a manner known in the art. The inclusion or entry of recovery drive serial number into the backup file can occur at any time. For example, the serial number can be permanently included in backup file in advance of the time that a backup is to occur, whereupon subsequent execution of the backup file now including recovery drive serial number can occur on demand. In another example, recovery drive serial number can be included in the backup file just prior execution of the backup file.

The backup file including recovery drive serial number can be executed whereupon, in response to executing the backup file, the operating system can mount the unmounted recovery drive 108 using recovery drive serial number. More specifically, processor 102 can use recovery drive serial number to establish communication with the unmounted recovery drive 108. Once communication is established between processor 102 and recovery drive 108, processor 102, operating under the control of the program stored in the backup file, can mount recovery drive 108. Thereafter, processor 102, acting under the control of the program stored in the backup file, can backup all or part of the file(s) and/or folder(s) stored on internal drive 104 to recovery drive 108. Once this backup is complete, processor 102, operating under the control of the program stored in the backup file, can unmount recovery drive 108. Following unmounting of recovery drive 108, the process of backing up one or more file(s) and/or folder(s) from internal hard drive 102 to recovery hard drive is complete.

In an example, the file(s) backed up to recovery drive 108 can be any type or form of file that can be stored on internal hard drive 104 and recovery drive 108. Non-limiting examples of such files include program files and data files. However, this is not to be construed in a limiting sense.

Internal drive 104 and recovery drive 108 can each be any suitable and/or desirable type of computer readable storage medium now know or hereinafter developed. Non-limiting examples of such computer readable storage medium can include a hard disk drive, a solid state drive, a flash drive (such as a USB flash drive or lighting flash drive), a CD Rom drive, and any other suitable and/or other desirable drive now known or hereinafter developed that is capable digitally storing data. This listing of types of drives, however, is not to be construed in a limiting sense.

In the event of an encrypting ransomware attack following the backup procedure described above, the files(s) and/or folder(s) stored in recovery drive 108 can be restored to internal drive 104. Specifically, backup drive 120 including a recovery program can be connected to processor 102 in any suitable and desirable manner. For example, backup drive 120 can be connected to a USB port 116 of system 100, can be connected to bus 110, or can be connected network interface 112. The particular type and style of backup drive 120 will determine how it is connected to processor 102. Accordingly, the foregoing examples of how backup drive 120 can be connected to processor 102 are not to be construed in a limiting sense.

Once backup drive 120 is connected to processor 102, recovery program executes, automatically or under the control of user. Recovery program causes processor 102 to mount recovery drive 108. Thereafter, recovery program executes the operating systems “restore” function which restores the file(s) and/or folders(s) stored on recovery drive 108 to internal drive 104 or a replacement internal drive 104. Thereafter, recovery program, once again, unmounts recovery drive 108.

Although the invention has been described in detail for the purpose of illustration based on what is currently considered to be the most practical preferred and non-limiting embodiments, examples, or aspects, it is to be understood that such detail is solely for that purpose and that the invention is not limited to the disclosed preferred and non-limiting embodiments, examples, or aspects, but, on the contrary, is intended to cover modifications and equivalent arrangements that are within the spirit and scope of the appended claims. For example, it is to be understood that the present invention contemplates that, to the extent possible, one or more features of any preferred and non-limiting embodiment, example, or aspect can be combined with one or more features of any other preferred and non-limiting embodiment, example, or aspect.

The invention claimed is:

1. A method of backup and recovery of file(s) and/or folder(s) stored on a non-volatile computer readable storage medium comprising:
(a) receiving, with a computer system comprising an internal drive and a processor running an operating system having the internal drive mounted to the operating system, a first instance of a serial number of a recovery drive operatively connected in communication with the processor, but not mounted, to the operating system;
(b) mounting, by the processor to the operating system, the recovery drive using the first instance of the serial number to communicate with the recovery drive;
(c) following step (b), copying, by the processor, of one or more files and/or one or more folders stored on the internal drive to the recovery drive;
(d) unmounting, by the processor from the operating system, the recovery drive using the first instance of the serial number;
(e) following step (d), executing by the processor encryption software;
(f) following step (e), receiving, with the computer system, a second instance of the serial number of the recovery drive;
(g) mounting, by the processor to the operating system, the recovery drive using the using the second instance of the serial number to communicate with the recovery drive;
(h) following step (g), copying, by the processor, the one or more files and/or the one or more folders stored on the recovery drive to the internal drive; and
(i) unmounting, by the processor from the operating system, the recovery drive using the first or second instance of the serial number.

2. The method of claim 1, wherein step (e) includes receiving the encryption software by an internet connection of the computer system.

3. The method of claim 1, wherein:
in step (a), the first instance of the serial number is included in a backup file stored on the internal drive; and
in step (e), the backup file is encrypted by the encryption software whereupon the first instance of the serial number included in a backup file is no longer available to the operating system.

4. The method of claim 1, wherein:
step (f) includes mounting, by the processor to the operating system, a backup drive that includes a recovery program that includes the second instance of the serial number; and
executing, by the processor, recovery program that causes the processor to execute steps (g)-(i).

5. The method of claim 4, wherein step (f) is executed by the processor automatically in response to connection of the backup drive in operative communication with the processor.
